(19) United States
(12) Patent Application Publication
(10) Pub. No.: US 2026/0245327 A1
(43) Pub. Date: Aug. 20, 2026

(54) IMAGE PROCESSING DEVICE, IMAGE PROCESSING METHOD, AND PROGRAM

(71) Applicant: HONDA MOTOR CO., LTD., Minato-ku, Tokyo (JP)

(72) Inventor: Tokitomo Ariyoshi, Wako-shi (JP)

(21) Appl. No.: 19/160,477

(22) PCT Filed: Mar. 1, 2023
(86) PCT No.: PCT/JP2023/007488

§ 371 Date: Aug. 28, 2025

(51) Int. Cl. G06V 10/24; B60W 50/14; G06F 21/62; G06V 10/82

(52) U.S. Cl. CPC G06V 10/24; B60W 50/14; G06F 21/6254; G06V 10/82; B60W 2050/143; B60W 2050/146

(57) ABSTRACT

An image processing device includes a first acquisition unit configured to capture images of a face of a person in a time-series order and acquire a plurality of anonymized images obtained by performing anonymization processing thereon, an identification unit configured to identify a target time point among a plurality of time points at which the plurality of anonymized images are captured, a second acquisition unit configured to acquire direction information of the face of the person at time points before and after the target time point, a calculation unit configured to calculate direction information of the face of the person at the target time point on the basis of the acquired direction information of the face of the person at time points before and after the target time point, and a correction unit configured to correct the face of the person captured in the anonymized image at the target time point on the basis of the calculated direction information of the face of the person at the target time point.

### TECHNICAL FIELD

The present invention relates to an image processing device, an image processing method, and a program.

### BACKGROUND ART

Conventionally, a technique for annotating an individual's face image in order to generate training data used for learning a machine learning model is known. For example, Patent Document 1 discloses a technique for generating a composite face image by referring to face images of multiple people stored in a face image database, and enabling annotation operations to be performed on the generated composite face image.

### CITATION LIST

### Patent Document

Patent Document 1: Japanese Patent No. 5930450

### SUMMARY OF INVENTION

### Technical Problem

The technology described in Patent Document 1 protects the privacy of a plurality of persons by having an annotator execute annotation operations on a composite face image obtained by compositing the face images of the plurality of persons. However, in the conventional technology, when face images to be anonymized are acquired in a time-series order, there are cases where the face images are not appropriately anonymized due to a malfunction of transformation processing at a certain time point, and anonymization processing of the time-series images cannot be appropriately executed.

The present invention has been made in consideration of such circumstances, and one of its objectives is to provide an image processing device, an image processing method, and a program that can appropriately perform anonymization processing on time-series images.

### Solution to Problem

The image processing device, image processing method, and program according to the present invention have adopted the following configurations.
(1): An image processing device according to one aspect of the present invention includes a first acquisition unit configured to capture images of a face of a person in a time-series order and acquire a plurality of anonymized images obtained by performing anonymization processing thereon, an identification unit configured to identify a target time point among a plurality of time points at which the plurality of anonymized images are captured, a second acquisition unit configured to acquire direction information of the face of the person at time points before and after the target time point, a calculation unit configured to calculate direction information of the face of the person at the target time point on the basis of the acquired direction information of the face of the person at time points before and after the target time point, and a correction unit configured to correct the face of the person captured in the anonymized image at the target time point on the basis of the calculated direction information of the face of the person at the target time point.
(2): In the aspect of (1) described above, the image processing device may further include a learning unit configured to acquire annotated images in which an annotation indicating whether a direction of the face of the person who drives a vehicle is appropriate is added to each of the plurality of corrected anonymized images, and generate a learned model for prompting the person to pay attention to pedestrians present outside the vehicle using the annotated images as learning data.
(3): In the aspect of (1) described above, the anonymization processing may be processing for changing the face of the person to a face of another person while matching the direction of the face of the person before and after the anonymization processing.
(4): In the aspect of (1) described above, the identification unit may identify, as the target time point, a time point at which the direction information of the face of the person does not match before and after the anonymization processing.
(5): In the aspect of (1) described above, the identification unit may identify, as the target time point, a time point at which the direction information of the face of the person is not present in an image before the anonymization processing is performed.
(6): An image processing method according to another aspect of the present invention includes, by a computer, capturing images of a face of a person in a time-series order and acquiring a plurality of anonymized images obtained by performing anonymization processing thereon, identifying a target time point among a plurality of time points at which the plurality of anonymized images are captured, acquiring direction information of the face of the person at time points before and after the target time point, calculating direction information of the face of the person at the target time point on the basis of the acquired direction information of the face of the person at time points before and after the target time point, and correcting the face of the person captured in the anonymized image at the target time point on the basis of the calculated direction information of the face of the person at the target time point.
(7): A program according to still another aspect of the present invention causes a computer to execute capturing images of a face of a person in a time-series order and acquiring a plurality of anonymized images obtained by performing anonymization processing thereon, identifying a target time point among a plurality of time points at which the plurality of anonymized images are captured, acquiring direction information of the face of the person at time points before and after the target time point, calculating direction information of the face of the person at the target time point on the basis of the acquired direction information of the face of the person at time points before and after the target time point, and correcting the face of the person captured in the anonymized image at the target time point on the basis of the calculated direction information of the face of the person at the target time point.

### Advantageous Effects of Invention

According to the aspects of (1) to (7) described above, it is possible to appropriately execute anonymization processing on time-series images.

### BRIEF DESCRIPTION OF DRAWINGS

FIG. 1 A diagram representing an outline of a system 1 including an image processing device 100 according to the present embodiment.

FIG. 2 A diagram representing an example of a functional configuration of the image processing device 100 according to the present embodiment.

FIG. 3 A diagram representing an example of a vehicle interior image and a vehicle exterior image acquired from a vehicle M1.

FIG. 4 A diagram for describing processing executed by an image processing unit 130.

FIG. 5 A diagram for describing processing executed by an image transformation unit 140.

FIG. 6 A diagram representing an example of time-series vehicle interior images converted by the image transformation unit 140.

FIG. 7 A diagram for describing calculation processing executed by an image correction unit 150.

FIG. 8 A diagram for describing correction processing executed by the image correction unit 150.

FIG. 9 A diagram representing an example of annotation work executed by an annotator.

FIG. 10 A diagram representing an example of driving assistance using a trained model 180.

FIG. 11 A diagram representing an example of a flow of processing executed by the image transformation unit 140.

FIG. 12 A diagram representing an example of a flow of processing executed by the image correction unit 150.

### DESCRIPTION OF EMBODIMENTS

Hereinafter, embodiments of an image processing device, an image processing method, and a program of the present invention will be described with reference to the drawings.

### Outline

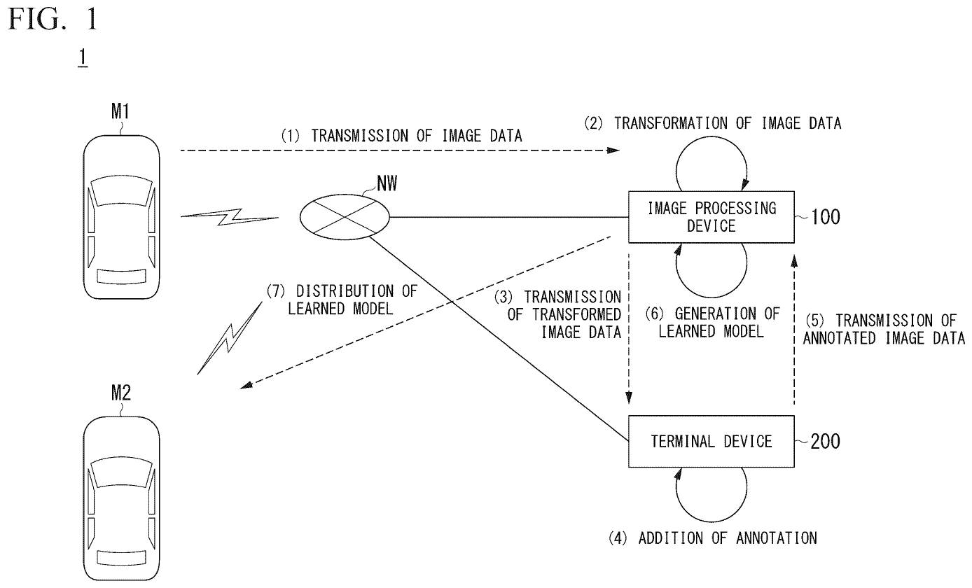

FIG. 1 is a diagram which shows an outline of a system 1 including an image processing device 100 according to this embodiment. As shown in FIG. 1, the system 1 includes at least one of a vehicle M1 and a vehicle M2, an image processing device 100, and a terminal device 200. For convenience of description, the vehicle M1 and the vehicle M2 are shown as different vehicles, but these vehicles may be the same.

The vehicle M1 is, for example, a vehicle such as a hybrid vehicle or an electric vehicle, and includes at least a camera that captures an image of an interior of the vehicle M1 and a camera that captures an image of an exterior of the vehicle M1. While the vehicle M1 is traveling, the vehicle interior image and the vehicle exterior image captured by these cameras are transmitted to the image processing device 100 via a network NW such as a cellular network, a Wi-Fi network, or the Internet.

The image processing device 100 is a server device that, if captured image data including a vehicle interior image and a vehicle exterior image is received from the vehicle M1, performs image transformation, which will be described below, on the received captured image data. This image transformation is processing of protecting privacy of a person captured in the vehicle interior image and the vehicle exterior image. The image processing device 100 transmits the obtained transformed image data to the terminal device 200 via the network NW.

The terminal device 200 is a terminal device such as a desktop computer or a smartphone. If the transformed image data is acquired from the image processing device 100, a user of the terminal device 200 performs work of adding annotations, which will be described below, to the acquired transformed image data. When the work of adding annotations is completed, the user of the terminal device 200 transmits the annotated image data, which is obtained by adding annotations to the transformed image data, to the image processing device 100.

When the image processing device 100 receives the annotated image data from the terminal device 200, it uses the received annotated image data as learning data and generates a learned model, which will be described below, using any machine learning model. This learned model is, for example, a behavior prediction model that, when a vehicle exterior image is input, outputs a predicted behavior (trajectory) of a person captured in the vehicle exterior image, or, when a vehicle interior image and a vehicle exterior image are input, takes into account a gaze of a driver captured in the vehicle interior image and prompts the driver to pay attention to pedestrians captured in the vehicle exterior image.

The image data used as the learning data at this time may be annotated image data which is obtained by adding annotations to the transformed image data, or it may be annotated image data which is obtained by re-transforming the transformed image data into captured image data while leaving the annotations as they are (that is, annotated image data which is obtained by adding annotations to captured image data). By using the annotated image data which is obtained by adding annotations to the captured image data as the learning data, it is possible to use learning data that is more realistic and in which effects of image transformation have been removed.

When the image processing device 100 generates the learned model, it distributes the generated learned model to the vehicle M2 via the network NW. Like the vehicle M1, the vehicle M2 is, for example, a vehicle such as a hybrid vehicle or an electric vehicle, and while the vehicle M2 is traveling, at least one of a vehicle interior image and a vehicle exterior image captured by a camera is input to the learned model to obtain behavior prediction data of a person present around the vehicle M2. A driver of the vehicle M2 can refer to the obtained behavior prediction data and use it to drive the vehicle M2. The following describes more detailed content of each piece of processing.

### Functional Configuration of Image Processing Device

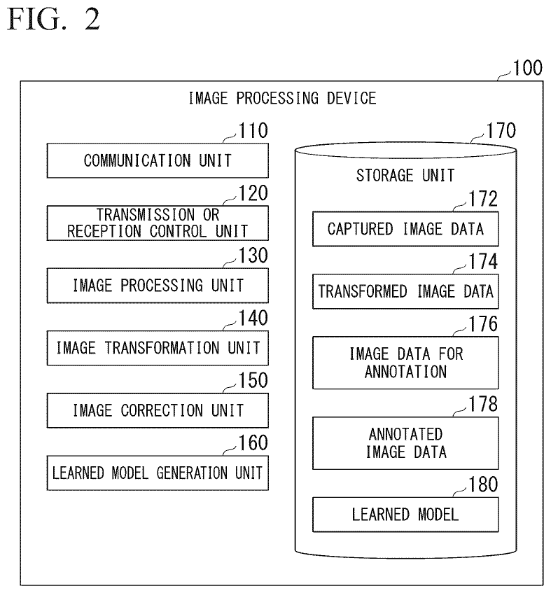

FIG. 2 is a diagram which shows an example of a functional configuration of the image processing device 100 according to the present embodiment. The image processing device 100 includes, for example, a communication unit 110, a transmission or reception control unit 120, an image processing unit 130, an image transformation unit 140, an image correction unit 150, a learned model generation unit 160, and a storage unit 170. These components are realized by, for example, a hardware processor such as a central processing unit (CPU) executing a program (software). Some or all of these components may be realized by hardware (a circuit unit; including circuitry) such as large scale integration (LSI), an application specific integrated circuit (ASIC), a field-programmable gate array (FPGA), or a graphics processing unit (GPU), or may be realized by software and hardware in cooperation. The program may be stored in advance in a storage device (a storage device having a non-transient storage medium) such as a hard disk drive (HDD) or a flash memory, or may be stored in a removable storage medium (non-transient storage medium) such as a DVD or a CD-ROM, and may be installed by mounting the storage medium in a drive device. The storage unit 170 is, for example, an HDD, a flash memory, a random access memory (RAM), or the like. The storage unit 170 stores, for example, captured image data 172, transformed image data 174, image data for annotation 176, annotated image data 178, and a learned model 180. For ease of description, the image processing device 100 includes a learned model generation unit 160 and a storage unit 170 that stores the learned model 180. However, a function of generating a learned model and the generated learned model may be held by a server device other than the image processing device 100. The learned model generation unit 160 is an example of a “learning unit.”

The communication unit 110 is an interface that communicates with a communication device 10 of the vehicle M via the network NW. For example, the communication unit 110 includes a network interface card (NIC) and an antenna for wireless communication.

The transmission or reception control unit 120 uses the communication unit 110 to transmit and receive data between the vehicles M1 and M2 and the terminal device 200. More specifically, first, the transmission or reception control unit 120 acquires from the vehicle M1 a plurality of vehicle interior images and vehicle exterior images captured in a time-series order by a camera mounted on the vehicle M1. In this case, “in a time-series order” means, for example, capturing images at a predetermined interval (for example, every second) during one driving cycle of the vehicle M1 from starting to stopping.

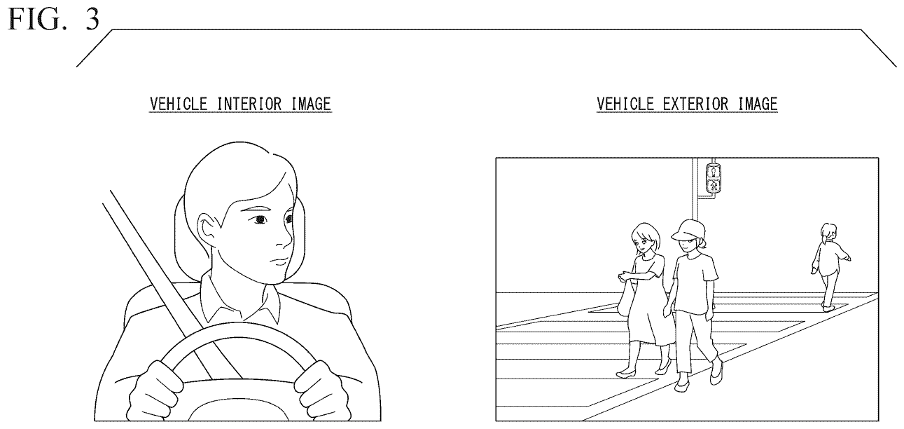

FIG. 3 shows an example of the vehicle interior image and the vehicle exterior image acquired from the vehicle M1. A left part of FIG. 3 represents the vehicle interior image acquired from the vehicle M1, and a right part of FIG. 3 represents the vehicle exterior image acquired from the vehicle M1. As shown in the left part of FIG. 3, the vehicle interior image is captured with a camera installed to capture at least a face area of the driver of the vehicle M1, and as shown in the right part of FIG. 3, the vehicle exterior image is captured with a camera installed to capture at least an area ahead in a traveling direction of the vehicle M1. The transmission or reception control unit 120 associates the vehicle interior image and vehicle exterior image acquired from the vehicle M1 with an image ID and stores them in the storage unit 170 as the captured image data 172.

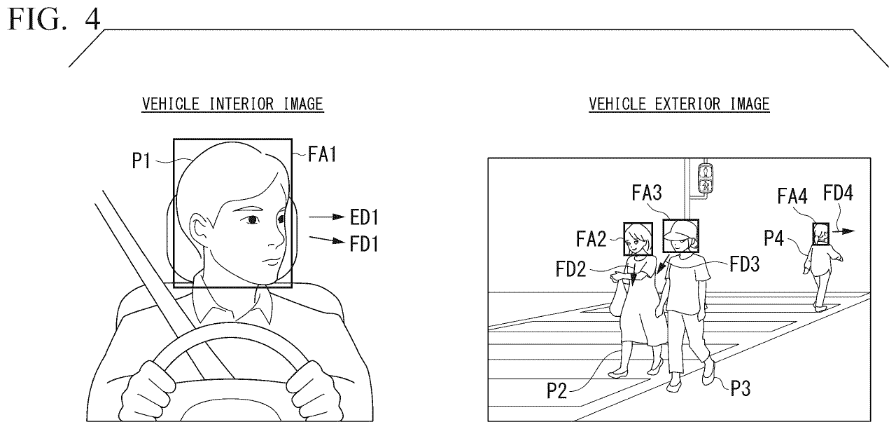

FIG. 4 is a diagram for describing processing executed by the image processing unit 130. The image processing unit 130 performs image processing on the captured image data 172 and acquires information such as image attributes, face attributes, and orientations of each image included in the captured image data 172. More specifically, when an image is input, the image processing unit 130 uses a learned model that outputs a result of classification indicating whether the image is a vehicle interior image or a vehicle exterior image to acquire image attributes indicating whether each image included in the captured image data 172 is a vehicle interior image or a vehicle exterior image.

Furthermore, when an image is input, the image processing unit 130 uses a learned model that outputs, for all faces included in the image, a face area, a size of a face (an extent of the face area), and a distance from an image capturing position to the face to acquire the face attributes of each image included in the captured image data 172. In FIG. 3, as an example, a face area FA1 of a person P1 is acquired from the vehicle interior image, and a face area FA2 of a person P2, a face area FA3 of a person P3, and a face area FA4 of a person P4 are acquired from the vehicle exterior image. For convenience, the face areas FA1, FA2, FA3, and FA4 are acquired as rectangular areas, but the present invention is not limited to such a configuration, and for example, a learned model that acquires face areas along contours of the faces of the persons may also be used.

Furthermore, when an image is input, the image processing unit 130 acquires direction information of faces captured in each image included in the captured image data 172 using a learned model that outputs at least one of face directions and gaze directions of all faces included in the image, for example as a vector. More specifically, for an image in the captured image data 172 having vehicle interior image attributes, the image processing unit 130 uses a learned model that, when an image is input, outputs face directions and gaze directions of all faces included in the image to acquire direction information. On the other hand, for an image in the captured image data 172 having vehicle exterior image attributes, the image processing unit 130 uses a learned model that, when an image is input, outputs face directions of all faces included in the image to acquire direction information. This is because, in general, faces captured in a vehicle interior image tend to be closer to an image-capturing position than faces captured in a vehicle exterior image, and to be captured large enough to extract the gaze directions. In FIG. 3, as an example, a face direction FD1 and a gaze direction ED1 of the person P1 are acquired from the vehicle interior image, and a face direction FD2 of the person P2, a face direction FD3 of the person P3, and a face direction FD4 of the person P4 are acquired from the vehicle exterior image.

When the image processing unit 130 acquires image attributes, face attributes, and direction information of each image in the captured image data 172, it links these image attributes, face attributes, and direction information to a corresponding image and records them. Note that, as an example, in the description above, the image processing unit 130 acquires the image attributes, face attributes, and direction information using a learned model, but the present invention is not limited to such a configuration, and the image processing unit 130 may acquire these image attributes, face attributes, and direction information using any known method.

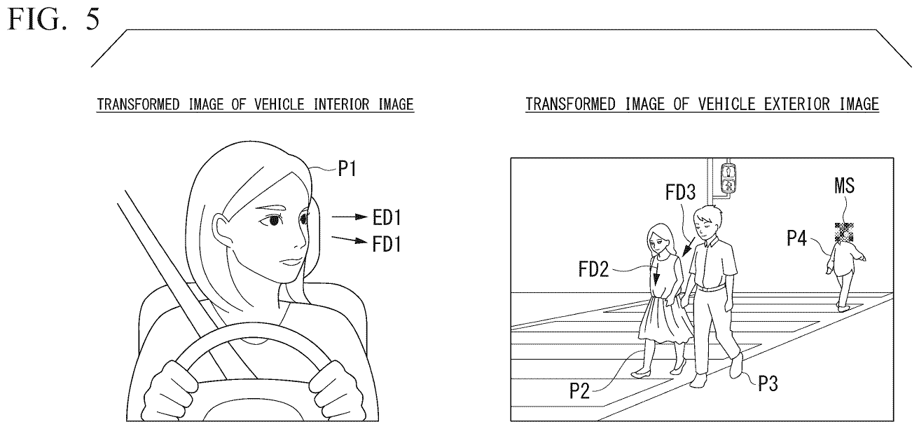

The image transformation unit 140 uses any face transformation software that has such a function to execute processing of replacing a face of a person captured in each image with a face of another person on the captured image data 172 processed by the image processing unit 130, without changing direction information of the person. FIG. 5 is a diagram for describing the processing executed by the image transformation unit 140. As shown in FIG. 5, the image transformation unit 140 replaces the faces of the persons P1, P2, and P3 shown in FIG. 4 with faces of other persons without changing the gaze direction ED1 and face directions FD1, FD2, and FD3. On the other hand, the face of person P4 is covered with a mosaic MS as a result of mosaic processing performed by the image transformation unit 140.

In other words, the image transformation unit 140 determines whether to replace the face with the face of another person or to apply mosaic processing to the face on the basis of the face attributes of each face captured in each image of the captured image data 172. More specifically, the image transformation unit 140 determines whether the size of each face captured in each image of the captured image data 172 is equal to or greater than a first threshold value Th1, and when it is determined that the size of the face is equal to or greater than the first threshold value Th1, it determines to replace the face with the face of another person. On the other hand, if it is determined that the size of the face is less than the first threshold value Th1, the image transformation unit 140 determines to apply mosaic processing to the face. Replacing the face of a person captured in a captured image with the face of another person or performing mosaic processing is an example of “anonymization processing.”

In addition, for each face captured in each image of the captured image data 172, the image transformation unit 140 determines whether a distance of a corresponding face is equal to or less than a second threshold value Th2, and when it is determined that the distance of the face is equal to or less than the second threshold value Th2, the image transformation unit 140 determines to replace the face with the face of another person. On the other hand, when it is determined that the distance of the face is greater than the second threshold value Th2, the image transformation unit 140 determines to apply mosaic processing to the face. The image transformation unit 140 repeatedly executes this determination processing of the number of faces captured in an image, and replaces each face with the face of another person or applies mosaic processing according to a result of the determination. The image transformation unit 140 stores the image data obtained by applying such processing to the captured image data 172 in the storage unit 170 as the transformed image data 174. This makes it possible to select useful data as learning data for generating a behavioral prediction model, and to protect the privacy of the person captured in each image when an annotator, which will be described below, performs annotation work.

At least one of the processing of determining whether the size of a face is equal to or greater than the first threshold value Th1 and the processing of determining whether the distance of the face is equal to or less than the second threshold value Th2 may be performed. When both pieces of processing are performed, the image transformation unit 140 may determine to replace the face with the face of another person when the size of the face is equal to or greater than the first threshold value Th1 and the distance of the face is equal to or less than the second threshold value Th2, or may determine to replace the face with the face of another person when the size of the face is equal to or greater than the first threshold value Th1 or the distance of the face is equal to or less than the second threshold value Th2.

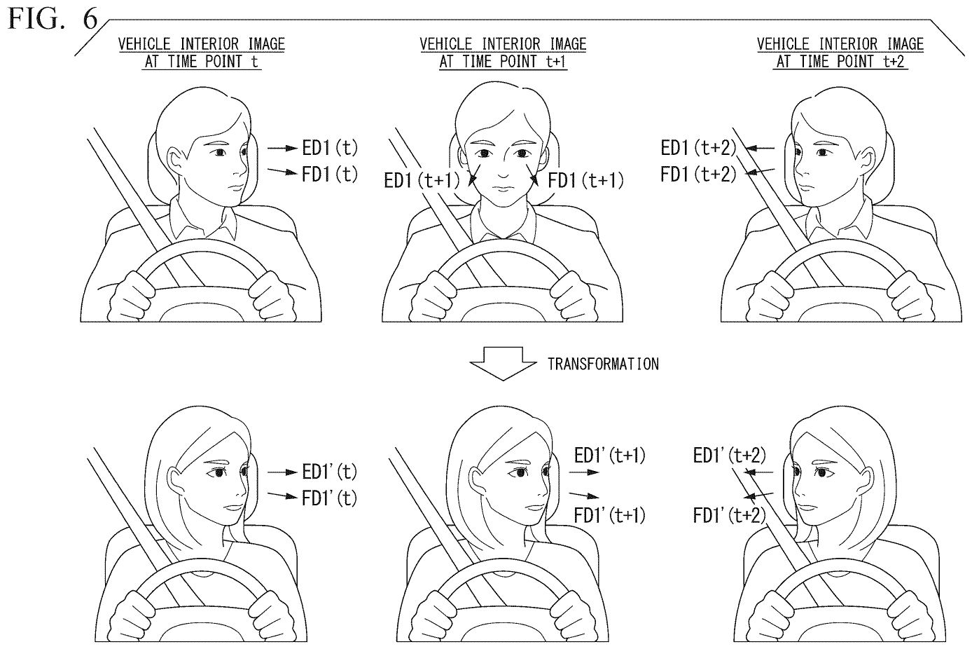

FIG. 6 is a diagram which shows an example of vehicle interior images in a time-series order, transformed by the image transformation unit 140. As an example, FIG. 6 represents an example of transformation of the vehicle interior images in a time-series order at three time points, t, t+1, and t+2. These vehicle interior images in a time-series order are images of capturing the same person and subjected to face transformation. However, as shown at a time point t+1 in FIG. 6, face transformation may be executed without maintaining direction information of the face of the person due to a malfunction of face transformation software, or the like. Even if a face image has been transformed without maintaining the direction information of the face of the person, using such transformed image data as learning data is undesirable because it may cause a deterioration in accuracy of the behavioral prediction model. For this reason, the image correction unit 150 executes the processing described below to correct a transformed image in which the direction information of the face of the person is not maintained before and after the transformation.

First, the image correction unit 150 inputs a transformed image at each time point into the learned model that outputs at least one of the face direction and gaze direction again, and acquires a face direction FD′ or a gaze direction ED′ in the transformed image. Next, for the face of a person captured in the transformed image, the image correction unit 150 determines whether the face direction FD′ or the gaze direction ED′ of the face approximately matches the face direction FD or the gaze direction ED of the face captured in a captured image before the transformation. More specifically, for example, the image correction unit 150 calculates an angle difference between a vector representing the face direction FD in the captured image before transformation and a vector representing the face direction FD′ in the transformed image, and determines that the face direction FD and the face direction FD′ approximately match when the calculated angle difference is within a threshold value. The same applies to the gaze direction ED.

When the image correction unit 150 determines that the face direction FD′ or the gaze direction ED′ of the face of the person captured in the transformed image does not approximately match the face direction FD or the gaze direction ED of the face captured in the captured image before transformation, it identifies a time point corresponding to the image as a target time point at which image correction is required. That is, in a case of FIG. 6, the image correction unit 150 identifies the time point t+1 as the target time point.

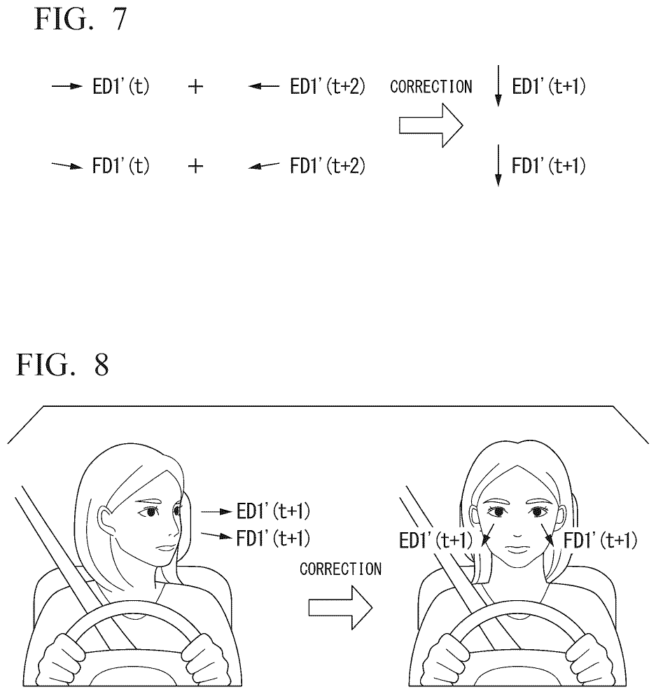

When the image correction unit 150 identifies a target time point at which image correction is required, it calculates the direction information of the face of the person at the target time point on the basis of the direction information of the face of the person at time points before and after the identified target time point. FIG. 7 is a diagram for describing calculation processing executed by the image correction unit 150. FIG. 7 represents, as an example, a case where the image correction unit 150 calculates the direction information at the time point t+1 on the basis of the direction information at the time point t and time point t+2.

As shown in FIG. 7, for example, the image correction unit 150 calculates a vector representing a gaze direction ED1′(t+1) at the time point t+1 by calculating an average vector of a vector representing a gaze direction ED1′(t) at the time point t and a vector representing a gaze direction ED1′(t+2) at the time point t+2. Similarly, for example, the image correction unit 150 calculates a vector representing a face direction FD1′(t+1) at the time point t+1 by calculating an average vector of a vector representing a face direction FD1′(t) at the time point t and a vector representing a face direction FD1′(t+2) at the time point t+2. Note that the calculation of the direction information of the face of the person at the target time point is not limited to taking an average of vectors representing direction information at the previous and next time points, and may be sufficient as long as at least the direction information at the previous and next time points is considered. Furthermore, in FIG. 7, an example is described in which the direction information at the target time point is calculated using the direction information ED1′ and FD1′ at the previous and next time points in the transformed image, but the present embodiment is not limited to such a configuration. An average vector may be calculated using the direction information ED1(t), ED1(t+2), FD1(t), and FD1(t+2) at the previous and next time points in an image before transformation, and this may be used as the direction information at the target time point.

The image correction unit 150 calculates the direction information of the face of the person at the target time point, and corrects the face of the person captured in the transformed image on the basis of the calculated direction information. FIG. 8 is a diagram for describing the correction processing executed by the image correction unit 150. As an example, FIG. 8 shows a case where the image correction unit 150 corrects the face of the person captured in the transformed image at the time point t+1 on the basis of the calculated direction information at the time point t+1. The image correction unit 150, for example, specifies the calculated direction information at the time point t+1 to the face transformation software (software which has a correction function for the transformed face in addition to the face transformation function) used by the image transformation unit 140 described above, and the face transformation software corrects the face of the person captured in the transformed image to conform to the specified direction information. The correction of a direction of the face captured in the image may be executed using a known method. This makes it possible to acquire a transformed image in a time-series order in which the direction information is correctly stored.

The image correction unit 150 may also identify, as the target time point at which image correction is required, a time point at which the direction information of the face of the person is not present in the image before anonymization processing is performed (in other words, when acquisition of the direction information has failed).

Here, the time point at which the direction information is not present means, for example, a case where the learned model fails to output the direction information due to light hitting the face of the person or an obstruction being present between the person and a camera. Furthermore, in this case, the failure includes a case where the face of the person itself cannot be obtained in the transformed image or reliability of the output direction information is low, in addition to a case where the direction information is not output. Even in such a case, the image correction unit 150 can use the method described above to calculate the direction information of the target time point on the basis of the direction information before and after the target time point, and correct the transformed image on the basis of the calculated direction information.

When the image correction unit 150 completes image correction for all identified target time points, it stores the corrected transformed image data 174 in the storage unit 170 as the image data for annotation 176. At this time, the transformed image data 174 may be stored in the storage unit 170 as the image data for annotation 176, together with information indicating a purpose of use, for example, information indicating that the image data is image data for annotation to generate a behavioral prediction model that predicts a behavior of a person captured in the input image. The transmission or reception control unit 120 transmits the image data for annotation 176 to the terminal device 200. An annotator, who is a user of the terminal device 200, generates annotated image data by performing annotation work on an image for annotation included in the received image data for annotation 176, and transmits it to the image processing device 100. The image processing device 100 stores the received annotated image data in the storage unit 170 as the annotated image data 178.

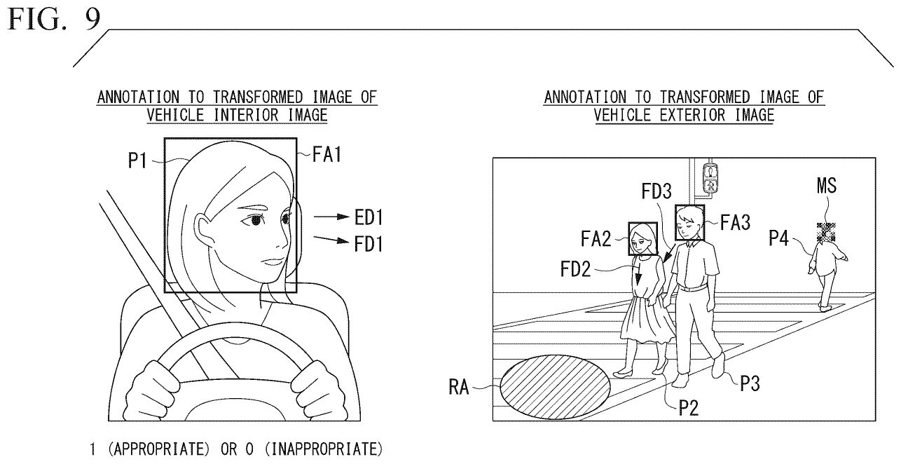

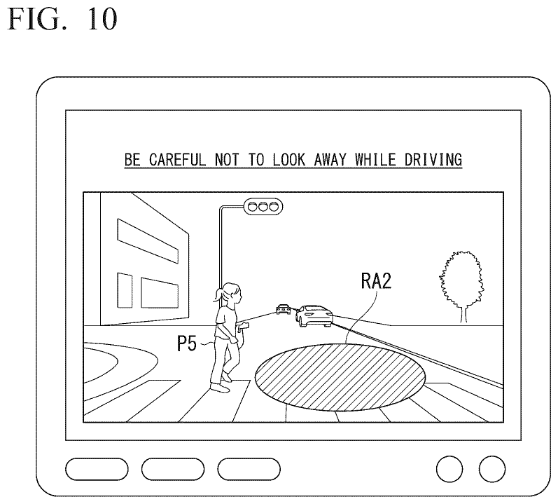

FIG. 9 is a diagram which shows an example of annotation work performed by the annotator. A left part of FIG. 9 represents annotations made to a transformed image of the vehicle interior image, and a right part of FIG. 9 represents annotations made to a transformed image of the vehicle exterior image. The annotator assigns, for example, information indicating whether the gaze direction ED1 of a driver captured in the transformed image is appropriate in a situation shown in the transformed image of the vehicle exterior image at the same time (for example, 1 if appropriate, 0 if inappropriate) to the transformed image of the vehicle interior image. For example, in the case of FIG. 9, the transformed image of the vehicle exterior image indicates that pedestrians are present on a left side in the traveling direction of the vehicle, while the transformed image of the vehicle interior image indicates that the driver is directing his or her gaze to the left. In other words, since it is assumed that the driver is paying appropriate attention to the pedestrians, the annotator assigns information indicating that the gaze direction ED1 of the driver is appropriate (that is, 1). In addition, FIG. 9 shows, as an example, a scene in which the annotator performs annotation work on a face in which the gaze direction ED1 has not been corrected. However, when the gaze direction ED1 is corrected, the annotator will perform annotation work while referring to a gaze direction ED1′ after correction.

Furthermore, the annotator specifies for the transformed image of the vehicle exterior image, for example, a risk area RA in which a person captured in the transformed image is predicted to progress, excluding a person that has been subjected to mosaic processing. Because the face of a person captured in an original image has been transformed into the face of another person through processing by the image transformation unit 140 and the image correction unit 150, the privacy of the person is protected. At the same time, since a face direction and a gaze direction of the person are maintained even after the transformation, the annotator can accurately specify the risk area RA while referring to the face direction and the gaze direction of another person captured in the transformed image. As a result, it is possible to generate learning data that is effective for learning a machine learning model while protecting the privacy of a person captured in a face image.

When the annotated image data 178 is stored in the storage unit 170, the learned model generation unit 160 uses the annotated image data 178 as learning data and generates a learned model using any machine learning model. As described above, this learned model is a behavioral prediction model that, for example, when a vehicle exterior image is input, outputs a predicted behavior (trajectory) of a person captured in the vehicle exterior image, or when a vehicle interior image and a vehicle exterior image are input, takes into account the gaze of the driver captured in the vehicle interior image to prompt the driver to pay attention to pedestrians captured in the vehicle exterior image.

The learned model generation unit 160 stores the generated learned model in the storage unit 170 as the learned model 180.

When the learned model 180 is generated, the transmission or reception control unit 120 distributes the generated learned model 180 to the vehicle M2 via the network NW. When the vehicle M2 receives the learned model 180, it uses the learned model 180 (more accurately, an application program that uses the learned model 180) to perform driving assistance on the driver of the vehicle M2.

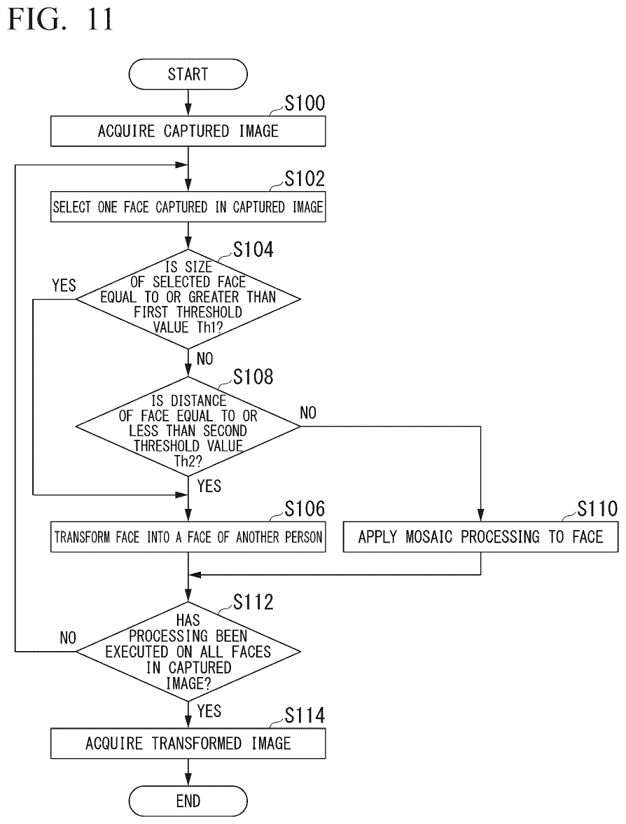

FIG. 10 shows an example of driving assistance using the learned model 180. FIG. 10 shows an example of performing driving assistance in which the vehicle M2 inputs a vehicle interior image and a vehicle exterior image captured by a camera mounted in the vehicle M2 while the vehicle M2 is traveling into the learned model 180, and the learned model 180 outputs information for prompting the driver to pay attention to pedestrians captured in the vehicle exterior image to a human machine interface (HMI), taking into account the gaze of the driver captured in the vehicle interior image. As shown in FIG. 10, for example, the HMI displays a risk area RA2 corresponding to a pedestrian P5 captured in the vehicle exterior image, and outputs a warning message (“Be careful not to look away while driving”) as text information or audio information when the gaze of the driver captured in the vehicle interior image is not directed toward the pedestrian P5. As a result, it is possible to realize driving assistance that takes into account a state of the driver.

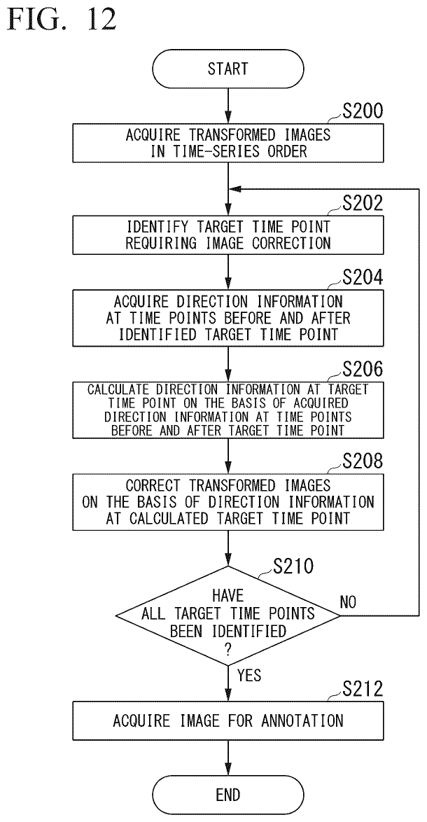

Next, a flow of processing executed by the image processing device 100 will be described with reference to FIGS. 11 and 12. FIG. 11 is a diagram which shows an example of a flow of processing executed by the image transformation unit 140. The processing shown in FIG. 11 is executed, for example, at a timing when a vehicle interior image or vehicle exterior image is captured by a camera mounted in the vehicle M1 and processed by the image processing unit 130.

First, the image transformation unit 140 acquires the captured image contained in the captured image data 172 that has been processed by the image processing unit 130 (step S100). Next, the image transformation unit 140 selects one face captured in the acquired captured image (step S102).

Next, the image transformation unit 140 determines whether a size of the selected face is equal to or greater than the first threshold value Th1 (step S104). When it is determined that the size of the selected face is equal to or greater than the first threshold value Th1, the image transformation unit 140 transforms the face into a face of another person (step S106). On the other hand, when it is determined that the size of the selected face is less than the first threshold value Th1, the image transformation unit 140 then determines whether a distance of the selected face is equal to or less than the second threshold value Th2 (step S108).

When it is determined that the distance of the selected face is equal to or less than the second threshold value Th2, the image transformation unit 140 proceeds to step S106 and transforms the face into a face of another person. On the other hand, when it is determined that the distance of the selected face is greater than the second threshold value Th2, the image transformation unit 140 applies mosaic processing to the face (step S110). Next, the image transformation unit 140 determines whether processing has been executed on all faces captured in the acquired captured image (step S112).

When it is determined that processing has been executed on all faces in the acquired captured image, the image transformation unit 140 acquires an image obtained by executing processing on all faces as a transformed image and stores it in the storage unit 170 as the transformed image data 174 (step S114). On the other hand, when it is determined that processing has not been executed on all faces in the acquired captured image, the image transformation unit 140 returns processing to step S102. As a result, the processing in this flowchart ends.

FIG. 12 is a diagram which shows an example of a flow of processing executed by the image correction unit 150. The processing shown in FIG. 12 is executed, for example, at a timing when transformed images in a time-series order are obtained by performing the transformation processing described above on captured images in a time-series order, captured during one traveling cycle from a start to a stop of the vehicle M1.

First, the image correction unit 150 functions as a first acquisition unit and acquires transformed images in a time-series order (step S200). Next, the image correction unit 150 functions as an identification unit and identifies a target time point of a person requiring image correction from the acquired transformed images in a time-series order (step S202).

Next, the image correction unit 150 functions as a second acquisition unit and acquires direction information of the face of the person at time points before and after the identified target time point (step S204). Next, the image correction unit 150 functions as a calculation unit and calculates direction information of the face of the person at the target time point on the basis of the acquired direction information of the face of the person at the time points before and after the target time point (step S206). Next, the image correction unit 150 functions as a correction unit and corrects the transformed images on the basis of the direction information of the face of the person at the calculated target time point (step S208).

Next, the image correction unit 150 determines whether all the target time points have been identified (step S210). When the image correction unit 150 determines that all the target time points have not been identified, it returns processing to step S202 and identifies other target time points (step S212). On the other hand, when the image correction unit 150 determines that all the target time points have been identified, it acquires the transformed images in a time-series order for which correction has been completed as images for annotation, and causes the transmission or reception control unit 120 to transmit the acquired images for annotation to the terminal device 200 (step S212). As a result, the processing of this flowchart ends.

According to the present embodiment described above, images of the face of a person are captured in a time-series order, and a plurality of anonymized images obtained by performing anonymization processing thereon are acquired. A target time point among a plurality of time points at which the plurality of anonymized images have been captured is identified, direction information of the face of the person at time points before and after the target time point is acquired, direction information of the face of the person at the target time point is calculated on the basis of the acquired direction information of the face of the person at the time points before and after the target time point, and the face of the person captured in the anonymized image at the target time point is corrected on the basis of the calculated direction information of the face of the person at the target time point. As a result, the anonymization processing of time-series images can be performed appropriately.

### Modified Example

In the present embodiment, an example has been described in which the image processing device 100 is mounted as a server device separate from the vehicle M1. However, as a modified example of the present embodiment, the image processing device 100, more specifically, a device having at least functions of the image processing unit 130, the image transformation unit 140, and the image correction unit 150, may be mounted on the vehicle M1 as an in-vehicle device. In this case, the in-vehicle device performs processing on an image captured by an in-vehicle camera using the image processing unit 130 described above, performs anonymization using the image transformation unit 140, and performs correction using the image correction unit 150.

The in-vehicle device then transmits the anonymized image after correction to an external image server.

When the image server receives an anonymized image from the vehicle M1, it stores the received anonymized image in the storage unit as image data for annotation, and transmits the image data for annotation to the terminal device 200 of the annotator, or allows the terminal device 200 to access the image data for annotation. When the image server receives annotated image data from the terminal device 200, it generates the learned model 180 on the basis of the annotated image data, and distributes the generated learned model 180 to the vehicle M2. In this manner, as in the present embodiment, it is possible to generate learning data that is effective for learning a machine learning model while protecting the privacy of the person captured in the face image. Furthermore, according to this modified example, the in-vehicle device performs anonymization processing on the image, and then transmits the anonymized image to the image server, so that the privacy of the person captured in the face image can be protected even more reliably.

Furthermore, as another aspect, the in-vehicle device may have only some of functions of the image processing unit 130, image transformation unit 140, and image correction unit 150, and the image server may have the remaining functions. For example, the in-vehicle device may have the functions of the image processing unit 130 and the image transformation unit 140, and the image server may have the function of the image correction unit 150, or the in-vehicle device may have the function of the image processing unit 130, and the image server may have the functions of the image transformation unit 140 and the image correction unit 150.

The embodiment described above can be expressed as follows.

An image processing device is configured to include a storage medium for storing computer-readable instructions and a processor connected to the storage medium, wherein the processor executes the computer-readable instructions to capture images of a face of a person in a time-series order and acquire a plurality of anonymized images obtained by performing anonymization processing thereon, identify a target time point among a plurality of time points at which the plurality of anonymized images are captured, acquire direction information of the face of the person at time points before and after the target time point, calculate direction information of the face of the person at the target time point on the basis of the acquired direction information of the face of the person at time points before and after the target time point, and correct the face of the person captured in the anonymized image at the target time point on the basis of the calculated direction information of the face of the person at the target time point.

Although the above describes a form for implementing the present invention using an embodiment, the present invention is not limited to such an embodiment, and various modifications and substitutions can be made within a range not departing from the gist of the present invention.

### REFERENCE SIGNS LIST

100 Image processing device
110 Communication unit
120 Transmission or reception control unit
130 Image processing unit
140 Image transformation unit
150 Image correction unit
160 Trained model generation unit
170 Storage unit
172 Captured image data
174 Converted image data
176 Image data for annotation
178 Annotated image data
180 Trained model

What is claim is:

1-7 (canceled)

8. An image processing device comprising:
a first acquisition unit configured to capture images of a face of a person in a time-series order and acquire a plurality of anonymized images obtained by performing anonymization processing thereon;
an identification unit configured to identify a target time point among a plurality of time points at which the plurality of anonymized images are captured;
a second acquisition unit configured to acquire direction information of the face of the person at time points before and after the target time point;
a calculation unit configured to calculate direction information of the face of the person at the target time point on the basis of the acquired direction information of the face of the person at time points before and after the target time point; and
a correction unit configured to correct the face of the person captured in the anonymized image at the target time point on the basis of the calculated direction information of the face of the person at the target time point.

9. The image processing device according to claim 8, further comprising:
a learning unit configured to acquire annotated images in which an annotation indicating whether a direction of the face of the person who drives a vehicle is appropriate is added to each of the plurality of corrected anonymized images, and
generate a learned model for prompting the person to pay attention to pedestrians present outside the vehicle using the annotated images as learning data.

10. The image processing device according to claim 8,
wherein the anonymization processing is processing for changing the face of the person to a face of another person while matching the direction of the face of the person before and after the anonymization processing.

11. The image processing device according to claim 8,
wherein the identification unit identifies, as the target time point, a time point at which the direction information of the face of the person does not match before and after the anonymization processing.

12. The image processing device according to claim 8,
wherein the identification unit identifies, as the target time point, a time point at which the direction information of the face of the person is not present in an image before the anonymization processing is performed.

13. An image processing method comprising:
by a computer,
capturing images of a face of a person in a time-series order and acquiring a plurality of anonymized images obtained by performing anonymization processing thereon;
identifying a target time point among a plurality of time points at which the plurality of anonymized images are captured;
acquiring direction information of the face of the person at time points before and after the target time point;
calculating direction information of the face of the person at the target time point on the basis of the acquired direction information of the face of the person at time points before and after the target time point; and
correcting the face of the person captured in the anonymized image at the target time point on the basis of the calculated direction information of the face of the person at the target time point.

14. A non-transitory computer-readable storage medium having stored thereon a program causing a computer to execute:
capturing images of a face of a person in a time-series order and acquiring a plurality of anonymized images obtained by performing anonymization processing thereon;
identifying a target time point among a plurality of time points at which the plurality of anonymized images are captured;
acquiring direction information of the face of the person at time points before and after the target time point;
calculating direction information of the face of the person at the target time point on the basis of the acquired direction information of the face of the person at time points before and after the target time point; and
correcting the face of the person captured in the anonymized image at the target time point on the basis of the calculated direction information of the face of the person at the target time point.
